(19) United States
(12) Patent Application Publication
(10) Pub. No.: US 2020/0216746 A1
(43) Pub. Date: Jul. 9, 2020

(54) POLYALKOXYLATED ALCOHOLS FOR POST-CHOPS OILFIELD RECOVERY

(71) Applicant: Dow Global Technologies LLC, Midland, MI (US)

(72) Inventors: Abu Mokhtarul Hassan, Pearland, TX (US); Biplab Mukherjee, Pearland, TX (US)

(21) Appl. No.: 16/647,822

(22) PCT Filed: Sep. 26, 2018
(86) PCT No.: PCT/US18/52787

§ 371 Date: Mar. 16, 2020

Related U.S. Application Data
(60) Provisional application No. 62/564,606, filed on Sep. 28, 2017.

(51) Int. Cl. C09K 8/584; E21B 43/16

(52) U.S. Cl. CPC C09K 8/584; E21B 43/16

(57) ABSTRACT

Embodiments relate to a method to stimulate additional oil recovery from a post-CHOPS well in an oil-bearing formation. Specifically, the method involves treating a post-CHOPS well in an oil-bearing formation with a composition comprising an aqueous solution of a polyoxylated secondary alcohol.

### FIELD

Embodiments relate to the recovery of oil from a post-CHOPS well in an oil-bearing formation. More particularly, embodiments relate to an improved method for recovery of oil from a post-CHOPS well in an oil-bearing formation using an aqueous solution of one or more polyoxylated alcohols.

### BACKGROUND

Oil can generally be separated into classes or grades according to its viscosity and density. Grades of oil that have a high viscosity (e.g., greater than 30,000 cP at room temperature) and density may be more difficult to produce from a reservoir to the surface. In particular, extra heavy oil requires enhanced oil recovery techniques for production. In the following description, the generic term “oil” includes hydrocarbons, such as extra heavy oil, as well as less viscous grades of oil.

A large portion of the world's potential oil reserves is in the form of heavy or extra heavy oil, such as the Orinoco Belt in Venezuela, the oil sands in Canada, and the Ugnu Reservoir in Northern Alaska. Currently, some existing oil reservoirs are exploited using thermal enhanced oil recovery techniques that usually result in recovery efficiencies within a range of about 20% to 75%. One of the most common thermally enhanced oil recovery techniques is steam injection by which heat enthalpy from the steam is transferred to the oil by condensation. The heating reduces the viscosity of the oil to allow drainage and collection. Thus, oil recovery is high if the temperature can be maintained near the temperature of the injected steam.

In deep reservoirs or thin reservoirs, much heat is lost through the wellbore to the rock surrounding the reservoir. Then traditional steam injection is little more than a hot water flood and loses much of its effectiveness in reducing the oil's viscosity and improving oil production.

A current practice is to use Cold Heavy Oil Production with Sand (“CHOPS”) for oil recovery (e.g., of high viscosity oil) from an oil-bearing formation. As the name implies, this utilizes primary production without heat. Improved for CHOPS are sought in an effort to improve an overall recovery factor for the oil-bearing formation.

### SUMMARY

Embodiments may be realized by providing a method to stimulate additional oil recovery from a post-CHOPS well in an oil-bearing formation wherein said post-CHOPS well has one or more injector, one or more producer, and one or more wormhole. The method comprising providing to the oil-bearing formation an aqueous solution comprising, consisting essentially of, or consisting of: (i) one or more linear secondary alcohol initiated polyethylene glycol (e.g., in an amount of 0.01 to 10 weight percent based on the weight of the aqueous solution) having the structure:

RO(CH₂CH₂O)ₙH I

wherein R is a linear alkyl group of from 3 to 16 carbons, preferably 12 to 16 carbons, n is an integer from 5 to 20, preferably 5, 7, 9, 12, 15, or 20, with the proviso that the polyethylene glycol chain is on any secondary carbon of the 3 to 16 linear alkyl carbon group R (e.g., in an amount to provide the aqueous solution a pH of equal to or greater than 10). The aqueous solution is injected into the oil-bearing formation through at least one of the one or more injector and the one or more producer.

In an exemplary embodiment, the linear secondary alcohol initiated polyethylene glycol has the structure II where the asterisks indicates the polyethylene glycol chain is on any secondary carbon and the bracket of 3 to 8 indicates a repeat of 3 to 8 carbons, corresponding to a distribution of C11 to C16 total chain lengths:

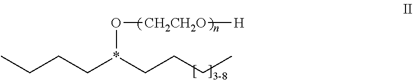

where n is selected from 5 to 20, preferably 5, 7, 9, 12, 15, or 20.

In an exemplary embodiment, the method disclosed herein above comprises, consists essentially of, or consists of (a) injecting the aqueous solution of the polyalkoxylated alcohol into one or more injector to introduce the aqueous solution of the polyalkoxylated alcohol into one or more one wormhole and (b) recovering released oil from one or more producer. In an exemplary embodiment, the method disclosed herein above further comprises, consists essentially of, or consists of between (a) and step (b) the steps of: (c) pressurizing the formation with gas, (d) pushing the polyalkoxylated alcohol solution deep inside the formation, (e) soaking of the formation with polyalkoxylated alcohol solution, and (f) reducing the formation pressure.

### BRIEF DESCRIPTION OF THE DRAWINGS

FIG. 1 is a photograph of oil transfer into water at various NaCl concentrations for Examples of the invention versus Comparative Examples not of the present invention.

FIG. 2 is a schematic of a flow through room temperature continuous imbibition core flood test.

FIG. 3 shows the results of the continuous imbibition test for an example of the invention.

### DETAILED DESCRIPTION OF THE EMBODIMENTS

Oil fields containing relatively thin layers of heavy oil in unconsolidated sandstone formations have been produced under primary production via a method that is commonly referred to as Cold Heavy Oil Production with Sand (CHOPS). The thin hydrocarbon-containing layers render steam flooding a non-viable option due to high heat losses to non-productive confining layers above and below. The crude oil is most effectively produced with progressive cavity pumps by allowing the sand to be produced concurrently with the oil and gas. Through a solution gas drive/pressure depletion mechanism, in some cases with contributing aquifer pressure support, a combination of foamy oil, gas, water, and sand are produced until the oil production tails off over time and water production increases to the point where it becomes uneconomical to continue production. At this point, the wells are generally suspended after only producing from 5% to 15% of the oil that was originally in place with an average of around 5% recovery. It is estimated there are as many as 30,000 of these suspended CHOPS wells in Canada alone.

For CHOPS, a well may be drilled into an unconsolidated reservoir, such as a highly porous tar sand formation. The well is perforated and a pumping device may be lowered into the well. The combination of reservoir pressure and artificial lift provided by the pumping device drives the oil in the reservoir to the well surface. Sand influx with the oil is encouraged by increasing the “draw down” pressure in the well (i.e., the differential pressure that drives fluids from the reservoir into the well), which enlarges the access of oil flow and decreases the resistance of fluid flow. A mixture of heavy oil and sand is produced and separated at the surface. Sand generation during CHOPS results in creation of highly permeable zones in areas surrounding the producer well, which allow greater fluid flux to the wellbore.

With more sand production, the permeable zones extend deep inside reservoirs in the form of highly branched and permeable channels known as “wormholes”. Interconnection of several wormholes inside the reservoir can give rise to highly networked porous channels with permeability around 10,000 mDarcy. One shortcoming of CHOPS is that the recovery efficiency can be as low as 5% of the original oil in place. Another shortcoming is that after the economic production limit is reached using the CHOPS process, the reservoir may not be suitable for other enhanced oil recovery techniques. As the number of potential heavy oil reservoirs increases and the complexity of the operating conditions of these reservoirs increases, there is a continuous need for efficient enhanced oil recovery techniques and methods to further an overall recovery factor for oil-bearing formations.

CHOPS oil production results in the formation of wormholes in the unconsolidated sand matrix. These relatively-open, highly-porous channels, or conduits, where the sand has been removed-in addition to the halo of disturbed sand surrounding them are beneficial during (primary) CHOPS production to facilitate the flow of the oil, water, gas, and sand mixture. These wormholes can be as large as 10 cm and can extend hundreds of meters into the formation. These wormholes, however, are often detrimental to subsequent secondary or tertiary recovery techniques, since they bypass large portions of the reservoir and lead to early water breakthrough, thereby severely degrading intended flooding sequences to improve sweep and promote contact with the more virgin areas of the formation. In the methods of the invention, these same wormholes can provide a high permeability pathway deep into the formation for introduction of the polyalkoxylated alcohol.

Embodiments relate to a method of stimulating additional oil recovery from a post-cold heavy oil production with sand (post-CHOPS) well in an oil-bearing formation. By post-CHOPS it is meant a well with an oil-bearing formation that has at least one wormhole and has completed primary CHOPS production. In exemplary embodiments, the primary CHOPS production may be completed after a recovery factor of at least 2%, at least 4%, at least 5%, at least 7%, at least 10%, at least 12% (original oil in place, based on total volume of oil stored in the oil-bearing formation prior to CHOPS production) has been achieved. For example, the primary CHOPS production may result in a recovery factor ranging from 2% to 15%. The post-CHOPS production can further increase the overall recovery factor for the oil-bearing formation by at least 1%.

The method comprises the steps of injecting an aqueous solution of a nonionic surfactant, preferably a polyalkoxylated alcohol, into the post-CHOPS oil-bearing formation via a well bore to introduce the aqueous solution of the polyalkoxylated alcohol into the oil-bearing formation, e.g., into the at least one wormhole within the post-CHOPS oil-bearing formation, and recovering oil from the post-CHOPS oil-bearing formation.

Suitable nonionic surfactants for use in the method are linear secondary alcohol initiated polyethylene glycols of the following structure I:

RO(CH₂CH₂O)ₙH I

wherein R is a linear alkyl group of from 3 to 16 carbons (e.g., 6 to 16 carbons, 12 to 16 carbons, 13 to 16 carbons, 14 to 16 carbons, 15 carbons, etc.), n is an integer from 5 to 20 (e.g., from 7 to 18, from 10 to 18, from 12 to 17, from 13 to 16, from 14 to 16, 5, 7, 9, 12, 15, or 20), with the proviso that the polyethylene glycol chain is on any secondary carbon of the C3 to C16 alkyl carbon group R.

In exemplary embodiments, the linear secondary alcohol initiated polyethylene glycol is a 11 to 15 carbon (C11-C16) or a 12 to 15 carbon (C12-C16) linear secondary alcohol initiated polyethylene glycols having a general structure II where the asterisks indicates the polyethylene glycol chain is on any secondary carbon and the bracket of 3 to 8 indicates a repeat of 3 to 8 carbons, corresponding to a distribution of C11 to C16 total chain lengths:

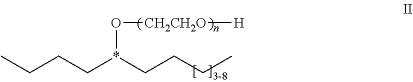

where n is selected from 5 to 20 (e.g., from 7 to 18, from 10 to 18, from 12 to 17, from 13 to 16, from 14 to 16, 5, 7, 9, 12, 15, or 20). It is understood that for any specific carbon chain length (i.e., C11 to C16), the polyethylene glycol chain may be bonded on one or more or all of the secondary carbons within the chain (secondary carbon defined herein as a carbon with two hydrogen bonds and two carbon or one carbon and one oxygen bond, i.e., —C—CH₂—C— or —C—CH₂—O—). For a specific carbon length, the polyethylene glycol chain may be on one or more or all secondary carbons, thus a linear secondary alcohol initiated polyethylene glycol may be a single compound or a mixture of two or more substituted secondary carbon isomers.

The one or more polyalkoxylated alcohol may be present in the aqueous solution in an amount equal to or greater than 0.01 weight percent, equal to or greater than 0.1 weight percent, equal to or greater than 0.5 weight percent, equal to or greater than 1.0 weight percent, equal to or greater than 1.5 weight percent, based on the weight of the aqueous solution.

The one or more polyalkoxylated alcohol may present in the aqueous solution in an amount equal to or less than 40.0 weight percent, equal to or less than 30.0 weight equal to or less than 25 weight percent, equal to or less than 20.0 weight percent, equal to or less than 15 weight percent, equal to or less than 10.0 weight percent, equal to or less than 5.0 weight percent, equal to or less than 3.0 weight percent, and/or equal to or less than 1.0 weight percent, based on the weight of the aqueous solution.

In one embodiment of the method of the present invention, the aqueous solution containing the polyalkoxylated alcohol is injected with produced water (or a suitable carrier) either alone or in combination with a base to make the formulation alkaline in nature (preferably pH equal to or greater than 10.0).

In one embodiment of the method of the present invention, the aqueous solution containing the polyalkoxylated alcohol further comprises, consists essentially of, or consists of a base. For example, the aqueous solution may further include at least one of a sodium salt and a potassium salt as the base. Exemplary bases include, but are not limited to, sodium carbonate, potassium carbonate, sodium hydroxide, potassium hydroxide, sodium bicarbonate, sodium metaborate sodium borate, potassium borate, and combinations thereof. In exemplary embodiments, the aqueous solution includes sodium carbonate, sodium hydroxide, and/or sodium metaborate.

If present, the base is present in the aqueous solution in an amount resulting in a solution pH of equal to or greater than 7 weight percent, equal to or greater than 10, equal to or greater than 12, and/or a pH equal to or greater than 13. The base (e.g., sodium salt and/or potassium salt) may be present in the aqueous solution in an amount from 0.1 weight percent to 40.0 weight percent, from 0.1 weight percent to 20.0 weight percent, from 0.1 weight percent to 15.0 weight percent, from 0.1 weight percent to 10.0 weight percent, from 0.1 weight percent to 8.0 weight percent, and/or from 0.1 weight percent to 6.0 weight percent, based on a total weight of water and the base. In exemplary embodiments, the water and the base may be pre-mixed prior to adding the secondary alcohol to form the aqueous solution.

In one embodiment of the method, the polyalkoxylated alcohol is non-ionic in nature but can be applied in combination with ionic chemistry, such as an ionic surfactant, to increase compatibility with the carrier or formation fluid

The present invention is a method to stimulate additional oil recovery from a post-CHOPS well in an oil-bearing formation wherein said well has one or more injector, one or more producer, and one or more one wormhole, said method comprising the step of providing to the oil-bearing formation an aqueous solution of one or more polyoxylated alcohol.

The aqueous solution may be provided to the oil-bearing formation of the post-CHOPS through at least one of the one or more injector and the one or more producer. In one embodiment, the method of the present invention is a flow through system comprising the steps of (a) injecting the aqueous polyoxylated alcohol solution (using produced water or any suitable water) into one or more well bore to introduce the aqueous solution of the polyalkoxylated alcohol into at least one of the one or more wormhole of the post-CHOPS well in an oil-bearing formation (e.g., via at least one of the one or more injector) and (b) then recovering released oil from at least one of the one or more producer.

In one embodiment, the method of the present invention comprises injecting an aqueous solution of the polyalkoxylated alcohol and recovering oil by utilizing Huff-and-Puff techniques, herein after referred to as WAHP (Water-Additive Huff and Puff). The WAHP method comprises the steps of: (a) injecting the aqueous solution of the polyalkoxylated alcohol into one or more injector to introduce the aqueous solution of the polyalkoxylated alcohol into one or more one wormhole, (b) pressurizing the formation with any suitable gas, such as carbon dioxide (CO₂), nitrogen (N₂), methane (CH₃), flue gas and the like or mixtures of hydrocarbons such as methane with any of ethane, propane, or butane, compressed natural gases, flue gas and the like (c) pushing the polyalkoxylated alcohol solution deep inside the formation, (d) soaking of the formation with polyalkoxylated alcohol solution, (e) reducing the formation pressure, and (f) recovering released oil from one or more producer.

The ambient temperature operation of the method of the present invention may reduce and/or eliminates the need for heat (e.g., additional heat to be provided). Another advantage is that produced water is inexpensive and is available in sufficient quantity in any oil fields.

### EXAMPLES

Example 1 has as an additive nonionic surfactant, which is a linear secondary alcohol initiated polyethylene glycol having the structure:

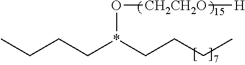

available as part of the TERGITOL™ series of surfactants from The Dow Chemical Company and the asterisks indicates the polyethylene glycol chain can be on any secondary carbon and, generally, the surfactant is represented by a distribution of structures on different secondary carbons.

Comparative Example A is a base line and does not have a nonionic surfactant additive.

Comparative Example B has an additive nonionic surfactant having the following structure:
2-ethylhexyl-O—(CH₂CH(CH₃)O)₈(C₂H₄O)₁₂H.

Comparative Example C has an additive nonionic surfactant that is branched primary alcohol alkyoxylate available as ECOSURF™ EH-9 from The Dow Chemical Company.

### Emulsification Test.

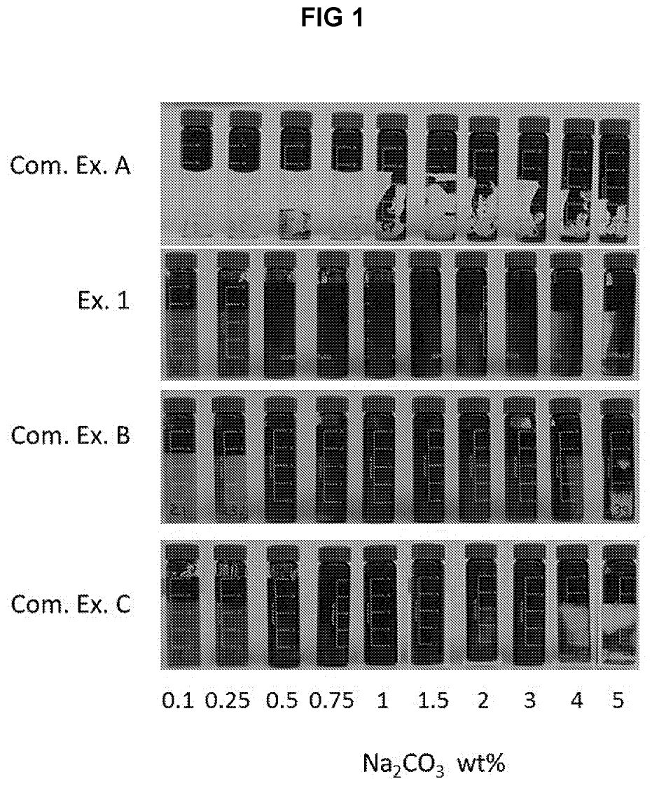

A shake test involving mixing three parts water and one part heavy oil is conducted at 50° C. The water is prepared by adding Na₂CO₃ in DI water at different concentrations of 0.1 wt % to 5.0 wt % (referring to FIG. 1). Experiments are conducted both at near neutral pH and ≥10.0 (pH is adjusted using Na₂CO₃) and also with field water. The oil used is dead oil obtained from the field and has a viscosity of greater than 40,000 cP at room temperature.

For the test, 3 parts of synthetic water followed by 1 part of heavy oil is transferred into a 25 ml glass vial. For treatments with the additive, the additive is added to water before hand to get a final concentration of 1000 ppm. The vial is then heated overnight at 50° C. in an oven and is the shaken at 80 rpm for 2 hours at 50° C. and is transferred back inside the oven and is allowed to settle overnight at 80° C. Photographs of the various samples one hour after shaking are shown in FIG. 1. Referring to FIG. 1, it is seen that improved miscibility between the heavy oil phase and the water phase is seen for Example 1, at varying concentrations of Na₂CO₃, as compared to Comparative Examples A, B, and C.

### Continuous Imbibition Test.

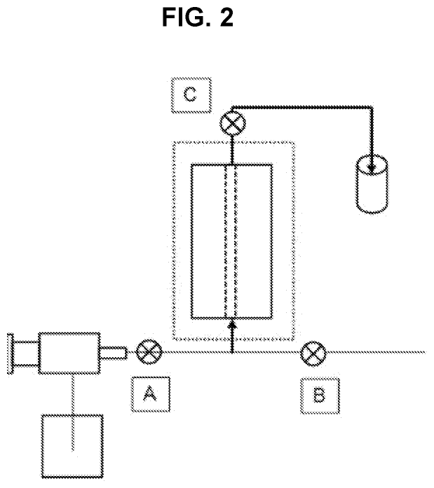

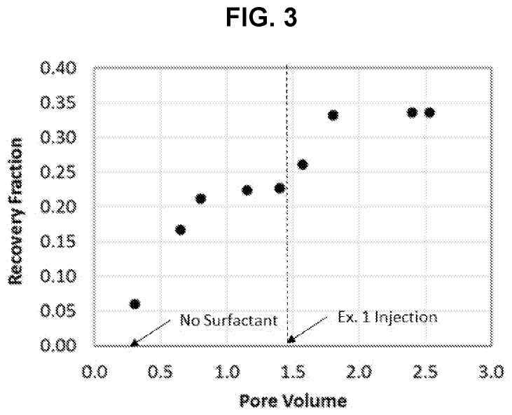

This test is done with a core that has a simulated wormhole in the middle (FIG. 2). Wormholes (or high permeability channels) are part of post-CHOPS reservoir. The porosity (30 to 35% without wormholes) and permeability (1000s mD) of the core is chosen such that it is good representation of what one can be expect in fields. Initially the wormhole is plugged and the core is saturated with water from a CHOPS field. Oil obtained from a reservoir (40,000 cP) is then passed through the core to fully saturate the core with oil and irreducible water concentration (12%). The worm hole that ran through the entire length of the central axis is then unplugged and it formed the high permeable channel. Any fluid injected will bypass the oil-rich core and go straight through the wormhole from point “A” to point “C” and get collected. For the experiment (FIG. 3), at first produced water (no surfactant) is injected which imbibed into the core and helped recover 23% of original oil in place (OOIP) over time. No more oil is recovered with further injection of produced water. Example 1 is then injected at 1000 ppm at a pH of 10 into the core, which results in additional improvement of 12.5% over the baseline.

1. A method of stimulating additional oil recovery from a post-CHOPS well in an oil-bearing formation, the method comprising:
providing to the oil-bearing formation of the post-CHOPS well an aqueous solution including:
one or more polyoxylated secondary alcohol having the structure:
RO(CH₂CH₂O)ₙH I
wherein R is a linear alkyl group of from 3 to 16 carbons,
n is an integer from 5 to 20, with the proviso that the polyethylene glycol chain is on any secondary carbon of the 3 to 16 linear alkyl carbon group R
wherein said post-CHOPS well has one or more injector, one or more producer, and one or more wormhole, the aqueous solution being injected into the oil-bearing formation through at least one of the one or more injector and the one or more producer.

2. The method of claim 1, wherein the aqueous solution is injected into at least one of the one or more wormhole.

3. The method of claim 1, wherein the polyoxylated secondary alcohol (i) has the structure: 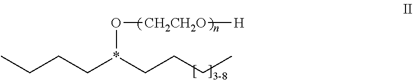
where n is selected from 5 to 20.

4. The method of claim 1, wherein the aqueous solution further includes at least one of a sodium salt and a potassium salt.

5. The method of claim 1, wherein the sodium salt is selected from at least one of sodium hydroxide, sodium carbonate, and sodium metaborate.

6. The method of claim 1, the method further including injecting the aqueous solution through the at least one of the one or more injector into at least one of the one or more one wormhole, and recovering released oil from at least one of the one or more producer.

7. The method of claim 6, further comprising pressurizing the formation with gas, pushing the polyalkoxylated alcohol solution deep inside the formation, soaking of the formation with polyalkoxylated alcohol solution, and reducing the formation pressure.

8. The method of claim 1, wherein the aqueous solution includes from 0.1 weight percent to 10 weight percent of the one or more polyoxylated secondary alcohol.
